(19) United States
(12) Patent Application Publication
(10) Pub. No.: US 2023/0041547 A1
(43) Pub. Date: Feb. 9, 2023

(54) DEVICE FOR GENERATING A MEASUREMENT SIGNAL

(71) Applicant: Bourns, Inc., Riverside, CA (US)

(72) Inventors: Johann Jahrstorfer, Munich (DE); Sebastian Berner, Taufkirchen (DE)

(21) Appl. No.: 17/784,249

(22) PCT Filed: Dec. 14, 2020
(86) PCT No.: PCT/IB2020/061914

§ 371 Date: Jun. 10, 2022

(30) Foreign Application Priority Data
Dec. 12, 2019 (DE) 102019219503.2

(51) Int. Cl. B62D 6/10; G01L 25/00; G01L 3/10; G01L 5/22

(52) U.S. Cl. CPC B62D 6/10; G01L 25/003; G01L 3/104; G01L 5/221

(57) ABSTRACT

The invention relates to a device (9) for generating a measurement signal (19) that is dependent on a torque (13) exerted on a torsion shaft (10) around a rotation axis (8) comprising: a magnet ring (16) fixed to a first axial position of the torsion shaft (10) and having a predefined number of magnet poles (28, 29) for generating a magnetic field (17), characterized by a magnet sensor (18) that is fixed to a second axial position of the torsion shaft (10) different from the first axial position and that includes a first sensor element (33) located in a radial plane (36) around the rotation axis (8) and outputting a first sensor signal dependent on the magnetic field (17) arriving the first sensor element (33), and a second sensor element (34, 38) located in the radial plane (36) of the first sensor element (33) but spaced from the first sensor element (33) with a distance (35) that is smaller that a cirumferencial extension of two neighboring magnet poles and outputting a second sensor signal dependent on the magnetic field (17) arriving the second sensor

The present invention relates to device for measuring a rotation angle around a rotation axis and a vehicle including that device.

A device for measuring a torque exerted on a torsion shaft around a rotation axis according to the preamble part of claim 1 is known from EP 1 870 684 A1. In the know device, the first sensor element used for detecting the torque and second sensor element for fail determination. The fail determination is made by a known process in which, for example, the outputs of the two sensor elements are compared in a time series, and, when there is a significant difference between the outputs, a determination is made that the sensor element which shows an unsteady output change before and after the significant difference is set into a fail condition.

It is object of the invention to improve the device.

The object is solved by the features of the independent claims. Advantageous embodiments are subject of the dependent claims.

According to an aspect of the invention, a device for generating a measurement signal that is dependent on a torque exerted on a torsion shaft around a rotation axis comprises a magnet ring fixed to a first axial position of the torsion shaft and having a predefined number of magnet poles for generating a magnetic field. The device is characterized by a magnet sensor that is fixed to a second axial position of the torsion shaft different from the first axial position and that includes a first sensor element located in a radial plane around the rotation axis and outputting a first sensor signal dependent on the magnetic field arriving the first sensor element and a second sensor element located in the radial plane of the first sensor element but spaced from the first sensor with a distance that is smaller that a cirumferencial extension of two neighboring magnet poles and outputting a second sensor signal dependent on the magnetic field arriving the second sensor element. The device further includes an evaluation system that is adapted to filter a stray field signal component from the first sensor signal based on the second sensor signal and to output the measurement signal based on the filtered sensor signal.

The first sensor element is preferably adapted to measure the magnetic field arriving the first sensor element in carthesic coordinates. Also the second sensor element is preferably adapted to measure the magnetic field arriving the second sensor element in carthesic coordinates.

The device is based on the thought that in the device mentioned in the beginning, the second sensor element can only be used to monitor the correct functionality of the first sensor element by plausibilizing its output first sensor signal against the second sensor signal. However, when the sensor elements are arranged in a common magnet sensor and located close together, an interference field that is superposed on the magnetic field of the magnet ring the first sensor signal and the second sensor signal will almost have the same amount in the first sensor signal as well as the second sensor signal and can thus be filtered out. The impact of the interference field can thus be reduced by 99%, which significantly stabilizes the post processing of the measurement signal for example in a steering control loop.

In an embodiment of the provided device, a radius r_{encoder} of an outer cirumference of the magnet ring and a displacement angle that is seen from the rotation axis and called φₑₗₑₘₑₙₜₛ hereinafter fulfills the equation

$${φ}_{elements} = a \cdot arctan ( \frac{1}{{r}_{encoder}} ) ,$$

wherein a is a value between 0.3 and 3. Within the provided range of a, the surface of the magnet ring appears to be flat for the magnet sensor on the one hand but guarantees that the different sensor elements gets independent magnetic measurement enabling to filter out the above mentioned interference field. The value a might preferably set to 2.

In a further embodiment of the provided device, each sensor element has a distance from the rotation axis that is between 3% and 15% of r_{encoder}, preferably 7%. In this distance range, the magnetic field of the magnet ring is sufficiently undisturbed enabling a precise detection torsion of the torsion element.

In a preferred embodiment of the provided device, the second sensor element is cirumferencially spaced from the first sensor element. Basically, the second sensor sensor element can be arbitrarily arranged on the radial plane around the first sensor element. However, when locating the second sensor element cirumferencially spaced from the first sensor element, the magnet ring can be structured very simply.

In a further embodiment of the provided device, the magnet sensor further includes a third sensor element cirumferencially positioned at and axially spaced from the first sensor element and outputting a third sensor signal dependent on the magnetic field arriving at the third sensor element, and a fourth sensor element cirumferencially positioned at the second sensor element, axially positioned at the third sensor element and outputting a fourth sensor signal dependent on the magnetic field arriving at the third sensor element, and wherein the circumferencial distance is smaller that half of a circumferencial extension of one magnet pole. By this means, the interference field can be canceled out from the sensor signals. This can be achieved most easily when filtering the stray field signal component from the first sensor signal by generating the quotient between a difference of the first sensor signal and the fourth sensor signal and a difference of the second sensor signal and the third sensor signal.

In a yet another embodiment of the provided device, the circumferencial distance is one third of the circumferencial extension of one magnet pole.

According to another aspect of the invention, a vehicle comprises a chassis that is moveable in a driving direction, two rear wheels moveably carrying the chassis on the rear side seen in the driving direction, two front wheels moveably carrying the chassis on the front side seen in the driving direction, a steering wheel for turning a steering column around a rotation axis for steering the front wheels, and one of the before provided devices for measuring a rotation angle of the steering column around the rotation axis.

The above described characteristics, features and advantages of this invention as well as the manner and way how they are achieved will get further comprehensive based on following description of the embodiments that will be explained in further detail in connection with the figures. It shows:

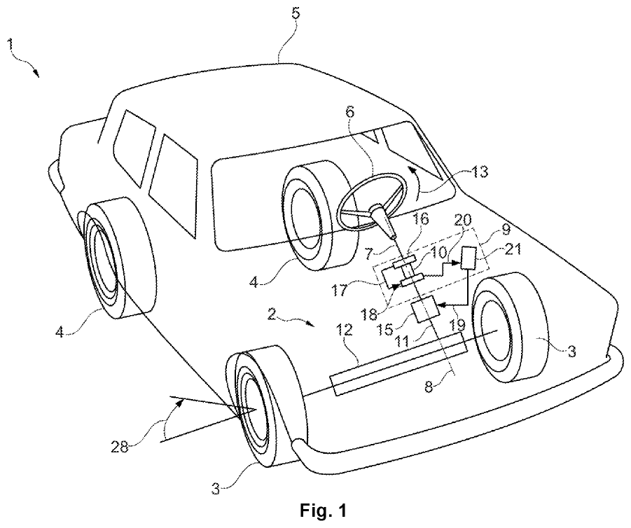

FIG. 1 in a perspective view a principle schematic of a car,

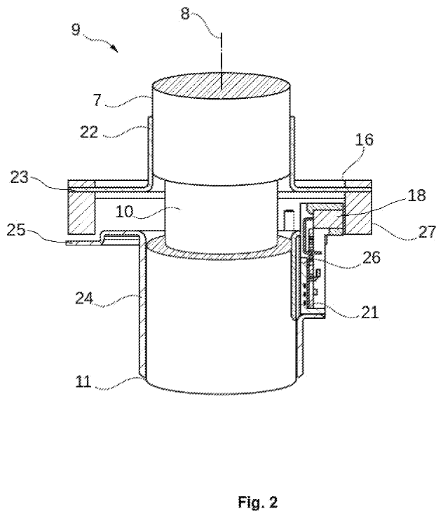

FIG. 2 in a sectional view a principle schematic of a device for measuring a rotation angle around a rotation axis in the car of FIG. 1,

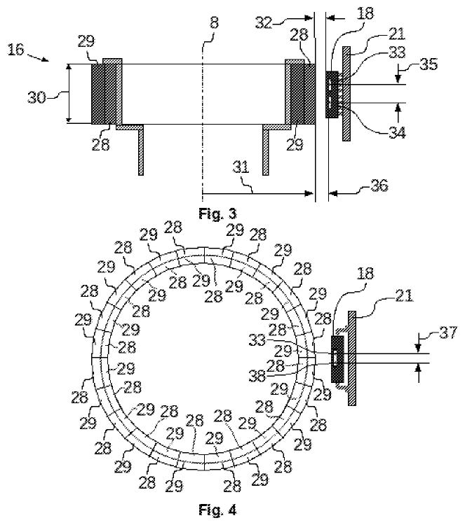

FIG. 3, in a sectional view a magnet ring and an integrated circuit with sensors in the device of FIG. 2 according to a first embodiment of the invention,

FIG. 4, in a top view the magnet ring and the integrated circuit in the device of FIG. 3,

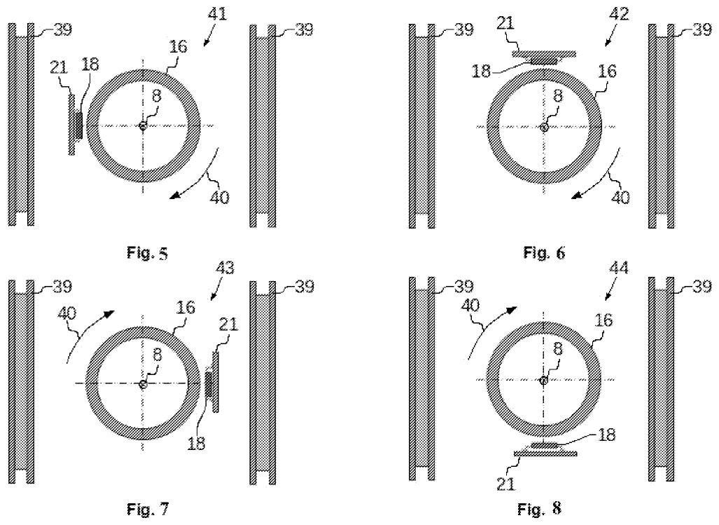

FIG. 5 in a top view the parts of FIGS. 5 and 6 in a measurement environment in a first arrangement,

FIG. 6 in a top view the parts of FIGS. 5 and 6 in a measurement environment in a second arrangement,

FIG. 7 in a top view the parts of FIGS. 5 and 6 in a measurement environment in a third arrangement,

FIG. 8 in a top view the parts of FIGS. 5 and 6 in a measurement environment in a fourth arrangement,

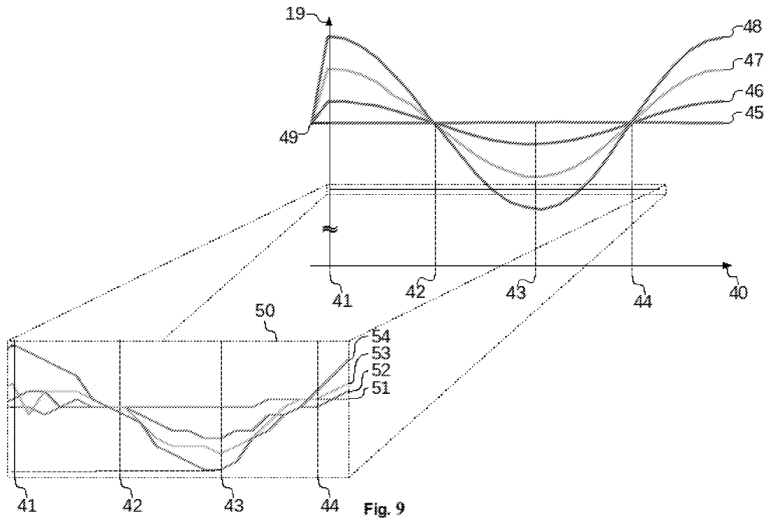

FIG. 9 a diagram with measurement results.

In the drawings, the same technical elements are provided with the same reference signs, and are only described once. The drawings are purely schematic, and, in particular, do not reflect the actual geometric proportions.

Reference is made to FIG. 1, which is a schematic perspective view of a vehicle 1 comprising a steering system 2.

In the present embodiment, the vehicle 1 comprises a chassis 5 supported by two front wheels 3 and two rear wheels 4. The front wheels 3 can be turned in a wheel angle 28 by the steering system 4 so that the vehicle 1 can be driven in a curve.

The steering system 2 comprises a steering wheel 6 which is mounted on a first steering shaft 7, which in turn is mounted so as to be able to rotate around a rotation axis 8. The first steering shaft 7 is guided into a device 9 for generating a measurement signal 19 that is dependent on a torque exerted on a torsion element 10 to which the first steering shaft 7 is connected in a way not shown in greater detail. A second steering shaft 11 is connected to said torsion element 10 on the side opposite the first steering shaft 7 on the rotation axis 8, and connected to a steering gear 12. If the steering wheel 6 is turned with a steering torque 13, the steering torque is transferred accordingly to the steering gear 12, which, in response, steers the front wheels 3 to drive in a curve with a wheel angle 28.

The steering process can be supported by an auxiliary motor 15 which can assist the second steering shaft 11 in turning. For this purpose, the device 9 detects the steering torque 13. The auxiliary motor 15 then steers the second steering shaft 11 inter alia according to the detected steering torque 13 with the wheel angle 28.

To detect the steering torque 13, the device 9 comprises a magnetic generator element in form of a magnet ring 16 which is connected to the first steering shaft 7, and which induces a magnetic field 17. The device 9 also comprises a magnet sensor 18 which is connected to the second steering shaft 11 and which measures the magnetic field 17 induced by the magnet ring 16 and dependent on a relative angular position of the first steering shaft 7 and thus of the magnetic ring 16 to the second steering shaft 11 and thus to the magnet sensor 18.

The magnet sensor 18 transmits a sensor signal array 20 to an evaluation system 21. The sensor signal array 20 will be described later in further detail. The evaluation system 21 receives the sensor signal array 21 an calculates generates thereon a measurement signal 19, that is dependent on the relative rotational position between the two steering shafts 7, 11 and thus on the torque exerted on the torsion shaft 10. This measurement signal 19 is then used to drive the auxiliary motor 15 for setting the wheel angle 28 based on the steering torque 13.

The device will now be described based on FIG. 2 in greater detail:

The first steering shaft 7 is pressed into a first receiving socket 22 that is rotatable around the rotation axis 8. The first receiving socket 22 further includes opposite to the first steering shaft 7 a flange 23 that carries the magnet ring 16, such that the magnet ring 16 will be turned around the rotation axis when first steering shaft 7 is turned. Likewise thereto, the second steering shaft 11 is pressed into a second receiving socket 24 that is also rotatable around the rotation axis 8. Therein, the second receiving socket 24 includes a flange 25 opposite to the second steering shaft 11. Attached to this flange 25 is a holder 26 that carries the evaluation system 21 being embodied as a printed circuit board in FIG. 2.

Together with the evaluation system 21, the holder 26 carries the magnet sensor on an axial level 27 of the magnet ring 16. As the torsion shaft 10 is twistable around the rotation axis 8, when the magnet ring 16 is turned around the rotation axis 8 due to the steering torque 13, the torsion shaft 10 will be twisted around the rotation axis 8 due to the inertia of the second steering shaft 11 such that the magnet ring 16 will be relatively displaced against the magnet sensor 18 in circumferencial direction around the rotation axis 8. This circumferencial displacement is the above mentioned relative angular position of the first steering shaft 7 to the second steering shaft 11. The magnetic field 17 from the magnet ring 16 arriving at the magnet sensor 18 will depend on this circumferencial displacement between the magnet magnet ring 16 and the magnet sensor 18. That is, the circumferencial displacement indicates the torsion of the torsion shaft 10 and consequently the steering torque 13 and can therefore be used to generate the above mentioned measurement signal 19

The before described measurement principle requires that the magnet field 17 from the magnetic ring 16 arrives undisturbed at the magnetic sensor 18. In a real environment, there are always external magnetic fields that disturb the magnetic field 17 of the magnetic ring 16.

The following description shows two embodiments that enable cancelling out external and disturbing magnet fields.

In the first embodiment, the magnet ring 16 as well as the magnet sensor 18 are embodied in a special form and schematically indicated in FIGS. 3 and 4.

The magnet ring 16 is circumferencially divided into a twenty four magnets, wherein each magnet has a north pole 28 and a south pole 29 radially adjoined to the north pole 28. Therefore, the magnet ring 16 in the first embodiment includes in sum forty eight magnet poles, wherein the magnet ring 16 includes a complete axial height 30 of 8 mm and a radius of 20.5 mm.

The magnet sensor 18 placed is radially displaced with an air gap 32 of 1.09 mm. The magnet sensor 18 includes a first sensor element 33 and a second sensor element 34 that are radially and circumferencially placed equally. The two sensor elements 33, 34 are axially displaced with an axial displacement 35 of 1.84 mm. Therein, a radial distance 36 of the sensor elements 33, 34 from the magnet ring 16 is 1.39 mm. The first sensor element 33 and the second sensor element 34 have the same axial distance from the axial pole boundary, wherein the first sensor element 33 is axially located at the axially upper magnet poles and a second sensor element 34 is axially located at the axially lower magnet poles.

Circumferencially displaced from the first and second sensor elements 33, 34 with a circumferencial distance 37 of 1.84 mm, a third sensor element 38 and a not shown fourth sensor element is placed.

Likewise to the first and second sensor element 33, 34, the third sensor element 38 and the fourth sensor element are radially and circumferencially placed equally. That is, the third sensor element 38 and the fourth sensor element are axially displaced with an axial displacement of 1.84 mm, and a radial distance 36 of the third sensor element 38 and the fourth sensor element from the magnet ring 16 is 1.39 mm. The third sensor element 38 and the fourth sensor element have the same axial distance from the axial pole boundary, wherein the third sensor element 38 is axially located at the axially upper magnet poles and a fourth sensor element is axially located at the axially lower magnet poles, such that the fourth sensor element is not visible in the perspectives of FIGS. 3 and 4.

The magnetic field 17 of the magnet ring 16 that arrives at the first sensor element 33 and the third sensor element 38 can be split up into a radial component Bᵣ, a circumferencial component Bₜ and a axial component Bₐ. At the axial position, where the magnet sensor 18 is placed, the axial magnetic field component Bₐ can be regarded as being constant with respect to the circumferencial displacement between the magnet magnet ring 16 and the magnet sensor 18 and can therefore be neglected. That is, the magnetic field 17 arriving at the magnet sensor 18 can be regarded as vectors rotating in an axial plane. The angle of a vector of the magnetic field 17 measured by one of the sensor element 33, 34 and 38 is directly dependent from the circumferencial displacement between the magnet magnet ring 16 and the magnet sensor 18 to be measured.

The angle of a vector of the magnetic field 17 measured by one of the sensor element 33, 34 and 38 can however not be measured directly, because each of the sensor element 33, 34 and 38 do not measure the magnetic field in cylindrical coordinates but in cartesian coordinates. For example, each of the sensor element 33, 34 and 38 can be embodied with three Hall generators, wherein each Hall generator measures the magnetic field 17 in one cartesian space direction.

Many magnet sensors, like the Melexis MLX90372 sold by Melexis NV at the application date of this patent application use at least two of the sensor elements 33, 34 and 38 that are circumferencially displaced to compare their measurement result and to filter a stray field, especially a disturbing magnetic fields. However, as one of the sensor elements, e.g. the sensor element 33 always cirumferencially leads the other of the sensor element, e.g. the sensor element 38, the application of many strategies for filtering a stray field are not feasible in an application in the magnet ring 16.

However, exemplary measurement tests with the above mentioned magnet sensor Melexis MLX90372 as the magnet sensor 18 have shown that the strategies for filtering a stray field can be trusted when the radius 31 of the magnet ring 16, called r_{encoder} hereinafter and the displacement angle 37 between the first sensor element 33 and the third sensor element 38 that is seen from the rotation axis 8 and called φₑₗₑₘₑₙₜₛ hereinafter fulfills the following equation:

$${φ}_{elements} = a \cdot arctan ( \frac{1}{{r}_{encoder}} ) \qquad ( 1 )$$

Therein, a is a value between 0.3 and 3.

This should be shown based on experiment results, wherein the value a has been chosen to be 2. An external and disturbing magnetic field have been experimentally cancelled out with a test set-up shown in FIGS. 5 to 8 that utilizes a Melexis MLX90372 as magnet sensor 18. Therein, the magnet ring 16 and the magnet sensor 18 together with the evaluation system 21 of the device 9 have been placed stationary to each other between two Helmholtz coils 39 that simulate the external and disturbing magnetic field.

Seen into the rotation axis 9, the Helmholtz coils 39 are arranged arranged point symmetric with respect to the rotation axis 9. The magnet ring 16 and the magnet sensor 18 that is for the experiment stationary to the magnet ring 16 are together rotatable around the rotation axis 9 by an arbitrary rotation angle 40. If assumed that FIG. 5 shows the test set-up in a first position 41 with a rotation angle 40 of 0°, FIG. 6 shows the test set-up in a second position 42 with a rotation angle 40 of 90°, FIG. 7 shows the test set-up in a third position 43 with a rotation angle of 180° and FIG. 8 shows the test set-up in a fourth position 44 with a rotation angle 40 of 270°.

Independent from whether using stray field filtering technique of the Melexis MLX90372 to generate the measurement signal 19 or whether only one single of the sensor elements 33, 34 and 38 are taken to generate the measurement signal 19, the measurement signal 19 should always output the same measurement signal 19, when no external and disturbing magnetic field is applied. The measurement signal 19 will only change over the rotation angle 40, if the Helmholtz coils 39 are turned on and apply an external and disturbing magnetic field to the test set-up.

In a first run of the test set-up, the measurement signal 19 had been generated with four different external and disturbing magnetic fields, wherein no stray field filtering strategy is applied. As already mentioned, this can be achieved by regarding for example only the output of one of the sensor elements 33, 34 or 38 of the magnet sensor 18.

The resulting curves are shown in FIG. 9. A first curve 45 shows the run of the measurement signal 19 generated with the magnet sensor over the rotation angle 40, when the external and disturbing magnetic field is 0 A/m. A second curve 46 shows the run of the measurement signal 19 generated with the prior art magnet sensor over the rotation angle 40, when the external and disturbing magnetic field is 1000 A/m. A third curve 47 shows the run of the measurement signal 19 generated with the prior art magnet sensor over the rotation angle 40, when the external and disturbing magnetic field is 2500 A/m and a fourth curve 48 shows the run of the measurement signal 19 generated with the prior art magnet sensor over the rotation angle 40, when the external and disturbing magnetic field is 4000 A/m.

As can be seen from FIG. 9, in case no external and disturbing magnetic field is applied, the measurement signal 19 keeps constantly on an operation point 49 of the device that includes the conventional magnet sensor. If an external and disturbing magnetic field is applied, the measurement signal 19 oscillates around the operation point 49 with not further referenced amplitudes that are dependent from the strength of the external and disturbing magnetic field.

In another run of the test set-up, the measurement signal 19 had further been generated by using the stray field filtering function of the Melexis MLX90372. Therein, the measurement signal 19 had been generated with the same four different external and disturbing magnetic fields as above. The resulting curves are shown in FIG. 9 in a window 50 that focuses out a part of the diagram of FIG. 9. A fifth curve 51 shows the run of the measurement signal 19 generated with the magnet sensor 18 over the rotation angle 40, when B_{dist}=0 A/m. A sixth curve 52 shows the run of the measurement signal 19 generated with the magnet sensor 18 over the rotation angle 40, when B_{dist}=1000 A/m. A seventh curve 53 shows the run of the measurement signal 19 generated with the magnet sensor 18 over the rotation angle 40, when B_{dist}=2500 A/m and a eighth curve 54 shows the run of the measurement signal 19 generated with the magnet sensor 18 over the rotation angle 40, when B_{dist}=4000 A/m.

As can be seen from FIG. 9, in case no external and disturbing magnetic field is applied, the measurement signal 19 that is generated with the magnet sensor 18 keeps constantly on an operation point 55 of the device 9 that includes the magnet sensor 18. If an external and disturbing magnetic field is applied, the measurement signal 19 oscillates around the operation point 55 with not further referenced amplitudes that are dependent from the strength of the external and disturbing magnetic field. These amplitudes are up to 99% smaller than the amplitudes of curves 45 to 48.

The measurement results therewith show that the embodiments described above reduce the influence of the external and disturbing magnetic field, even if the sensor elements of the magnet sensor 18 detect the magnetic field in carthesic coordinates.

1. Device for generating a measurement signal that is dependent on a torque exerted on a torsion shaft around a rotation axis comprising:
a magnet ring fixed to a first axial position of the torsion shaft and having a predefined number of magnet poles for generating a magnetic field, characterized by
a magnet sensor that is fixed to a second axial position of the torsion shaft different from the first axial position and that includes
a first sensor element located in a radial plane around the rotation axis and outputting a first sensor signal dependent on the magnetic field arriving the first sensor element, and
a second sensor element located in the radial plane of the first sensor element but spaced from the first sensor element with a distance that is smaller that a circumferential extension of two neighboring magnet poles and outputting a second sensor signal dependent on the magnetic field arriving the second sensor element,
an evaluation system that is adapted to filter a stray field signal component from the first sensor signal based on the second sensor signal and to output the measurement signal based on the filtered first sensor signal.

2. Device according to claim 1, wherein a radius γ_{encoder} of an outer circumference of the magnet ring and a displacement angle of the sensor elements that is seen from the rotation axis (8) and called φₑₗₑₘₑₙₜₛ hereinafter fulfills the equation
$${φ}_{elements} = a \cdot arctan ( \frac{1}{{γ}_{encoder}} ) ,$$
wherein a is a value between 0.3 and 3.

3. Device according to claim 1, wherein the first sensor element is adapted to measure the magnetic field arriving the first sensor element in carthesic coordinates, and wherein the second sensor element is adapted to measure the magnetic field arriving the second sensor element in carthesic coordinates.

4. Device according to claim 2, wherein each sensor element has a distance from the rotation axis that is between 3% and 15% of γ_{encoder}.

5. Device according to claim 4, wherein the second sensor element is circumferentially spaced from the first sensor element.

6. Device according to claim 5, wherein the magnet sensor further includes a third sensor element circumferentially positioned at and axially spaced from the first sensor element and outputting a third sensor signal dependent on the magnetic field arriving at the third sensor element, and a fourth sensor element circumferentially positioned at the second sensor element, axially positioned at the third sensor element and outputting a fourth sensor signal dependent on the magnetic field arriving at the third sensor element, and wherein the circumferencial distance is smaller that half of a circumferencial extension of one magnet pole.

7. Device according to claim 6, wherein the evaluation system is adapted filter the stray field signal component from the first sensor signal by generating the quotient between a difference of the first sensor signal and the fourth sensor signal and a difference of the second sensor signal and the third sensor signal.

8. Device according to claim 7, wherein the circumferencial distance is one third of the circumferencial extension of one magnet pole.

9. Vehicle comprising:
a chassis that is moveable in a driving direction,
two rear wheels moveably carrying the chassis on the rear side seen in the driving direction,
two front wheels moveably carrying the chassis on the front side seen in the driving direction,
a steering wheel for turning a steering column around a rotation axis for steering the front wheels, and
a device according to claim 8 for measuring a torque exerted on the steering column for steering the front wheels with an actuator.

10. Vehicle comprising:
a chassis that is moveable in a driving direction,
two rear wheels moveably carrying the chassis on the rear side seen in the driving direction,
two front wheels moveably carrying the chassis on the front side seen in the driving direction,
a steering wheel for turning a steering column around a rotation axis for steering the front wheels, and
a device according to claim 1 for measuring a torque exerted on the steering column for steering the front wheels with an actuator.

11. Device according to claim 2, wherein the first sensor element is adapted to
measure the magnetic field arriving the first sensor element in carthesic coordinates, and
wherein the second sensor element is adapted to measure the magnetic field arriving the second sensor element in carthesic coordinates.

12. Device according to claim 11, wherein each sensor element has a distance from the rotation axis that is between 3% and 15% y_{encoder}.

13. Device according to claim 4, wherein the second sensor element is circumferentially spaced from the first sensor element.

14. Device according to claim 5, wherein the magnet sensor further includes a third sensor element circumferentially positioned at and axially spaced from the first sensor element and outputting a third sensor signal dependent on the magnetic field arriving at the third sensor element, and a fourth sensor element circumferentially positioned at the second sensor element, axially positioned at the third sensor element and outputting a fourth sensor signal dependent on the magnetic field arriving at the third sensor element, and wherein the circumferential distance is smaller that half of a circumferential extension of one magnet pole.

15. Device according to claim 6, wherein the evaluation system is adapted filter the stray field signal component from the first sensor signal by generating the quotient between a difference of the first sensor signal and the fourth sensor signal and a difference of the second sensor signal and the third sensor signal.

16. Device according to claim 1, wherein the circumferential distance is one third of the circumferential extension of one magnet pole.

17. Device according to claim 3, wherein the circumferential distance is one third of the circumferential extension of one magnet pole.

18. Device according to claim 6, wherein the circumferential distance is one third of the circumferential extension of one magnet pole.
